(19) United States
(12) Patent Application Publication
(10) Pub. No.: US 2005/0114147 A1
(43) Pub. Date: May 26, 2005

(54) System and method for creating business process models by multi-modal conversation

(76) Inventors: Santosh Kumaran, Westchester County, NY (US); Prabir Nandi, Queens County, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/704,685

(22) Filed: Nov. 12, 2003

(51) Int. Cl. G06F 17/60

(52) U.S. Cl. 705/1

(57) ABSTRACT

An interactive tooling framework accepts multimodal input, including voice input, and responds with multimodal output, including synthesized voice output, to guide a user in progressively creating the business model. The business analyst starts by selecting the type of model he or she wants to create. The system then engages analyst in a (potentially long running) conversation where appropriate input is solicited from the analyst at different steps of creating the model.

### CROSS-REFERENCE TO RELATED APPLICATION

The subject matter of this application is related to that of co-pending U.S. patent application Ser. No. 10/128,864 filed Apr. 24, 2002, by James E. Hanson et al. for “Apparatus and Method for Providing Modular Conversation Policies for Agents” (IBM Docket YOR920020017US1) assigned to a common assignee herewith. The disclosure of application Ser. No. 10/128,864 is incorporated herein by reference.

### BACKGROUND OF THE INVENTION

1. Field of the Invention

The present invention generally relates to computer/user interactive systems and, more particularly, to an interactive tooling framework that can accept multimodal input, including voice input, and responds with multimodal output, including synthesized voice output, to guide a user in progressively creating a business model.

2. Background Description

State of the art tooling available for business analysts to create business process models is inherently passive and inflexible in nature. Typically, the tool will have a pallette of icons representing modeling artifacts. The analyst is given a graphical whiteboard where he or she drags one or more of these icons and wires them together to create the desired business process. This process sounds conceptually easy, but unfortunately it is far from easy in practical application. Each of these icons have some semantic meaning, and wiring between them also needs to be semantically correct. The tools are quite inflexible and unforgiving to wrong or partial input. In addition, the set of icons and their wiring vary from tool to tool based on the business model on which it is based on. Thus, the analyst has to go through a painful learning process before he or she can start to be productive. The analyst's expertise lies in the knowledge of the business, and he or she has a unique way of formalizing or visualizing it. Unfortunately, the current toolsets follow a “one size fits all” philosophy which, in most cases, is alien to the way the analyst thinks about their business.

### SUMMARY OF THE INVENTION

It is therefore an object of the present invention to provide an interactive tooling framework that can accept multimodal input, including voice input, and respond with multimodal output, including synthesized voice output, to guide the user in progressively creating a business process model.

According to the invention, the business analyst starts by selecting the type of model he or she wants to create. The system then engages analyst in a (potentially long running) conversation where appropriate input is solicited from the analyst at different steps of creating the model. The advantages of the invention are the following:
The analyst does not have to know the nuances of the business meta model. He or she simply responds by “talking” to the system.
The system expects erroneous input and engages in a side conversation to guide the analyst to provide the correct input.
A analyst with zero information technology (IT) skills can work with the system.
The invention has broad applicability at any level of tooling, business or otherwise.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram illustrating the architecture of a system on which the invention may be implemented;

FIG. 2 is a state machine diagram of the conversation policy (CP) for part of the play-in scenario required to gather information about artifacts involved in the business process in the preferred embodiment of the invention;

FIG. 3 is a state machine diagram of the CP for part of the play-in scenario required to gather information about tasks involved in the business process in the preferred embodiment of the invention; and

FIG. 4 is a block diagram illustrating the synthesized Just-in-Time (JIT) process model output by the specific embodiment of the invention.

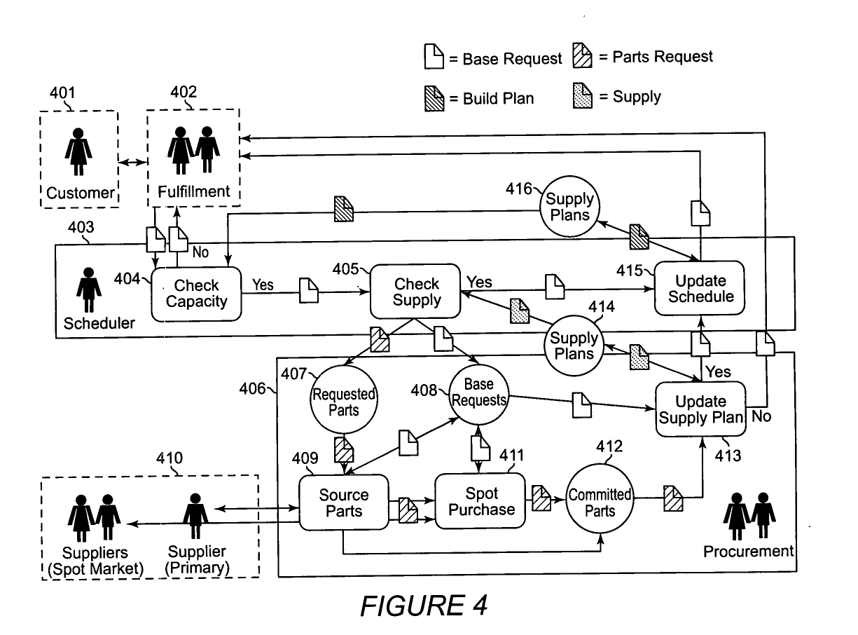

### DETAILED DESCRIPTION OF A PREFERRED EMBODIMENT OF THE INVENTION

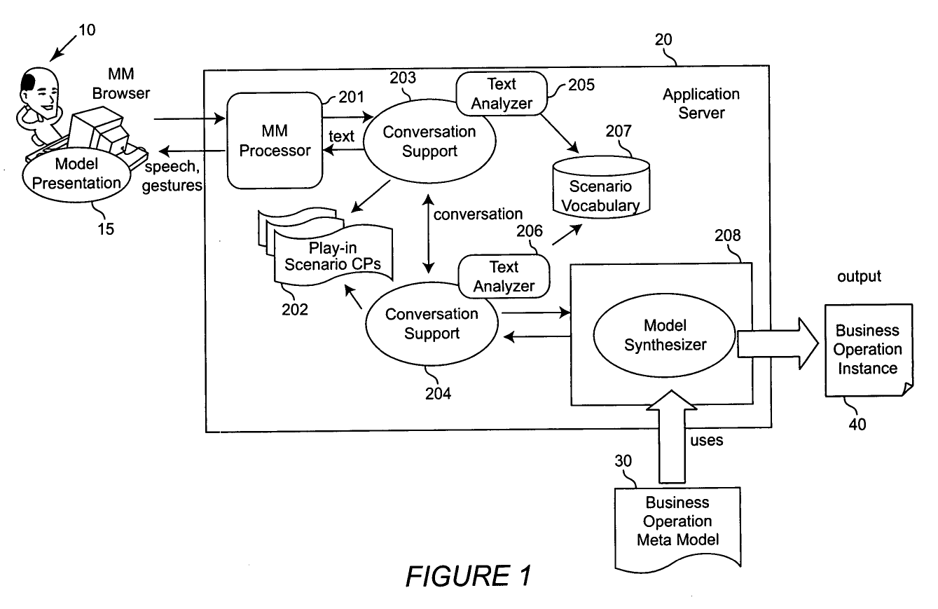

Referring now to the drawings, and more particularly to FIG. 1, there is shown a block diagram of the architecture of a system on which the invention may be implemented. The invention is based on known conversation support technology that provides the infrastructure to specify and execute the interaction between two or more conversation enabled systems. In this case, the conversational parties are the business analyst 10 and the application server 20. The analyst 10 interacts with the application server 20 by means of a computer interface 15 which includes a multimodal browser. The roles of the different components are described below.

The multimodal processor 201 is responsible for processing and converting input from the user to text, which may optionally be displayed to the analyst for visual feedback. The user input may be in the form of spoken words, keystrokes, mouse movements and clicks, and, if the computer interface is equipped with a video capture device, gestures. Similarly, the multimodal processor 201 converts text responses from the system to user output, including synthesized voice output. The text from the system may also be displayed. In other words, the multimodal processor 201 integrates the functions of a voice recognition system, image capture system and a voice synthesizer system, together with a keystroke and pointing device capture system and a display driver system, all of which is well known in the art.

The conversation policy is implemented in a play-in scenario conversation policies 202, for the user state conversation support module 203 and for the model state conversation support module 204. These conversation support modules 203 and 204 support the interactive play-in scenarios by which input is solicited and response is sent to/from the user. Each of the user state conversation support module 203 and the model state conversation support module 204 are, in turn, supported by respective text analyzers 205 and 206 which access a common scenario vocabulary database 207.

For different business models we could expect to have one or more such play-in conversation policies 202. For example, in modeling at the operation level, the scenario could start by asking for the list of transactions in the process. Another play-in scenario could start with listing the main business objects/artifacts of the process and then tasks that use and manipulate them.

The conversation support module 203 running on behalf of the user is responsible for maintaining the state of the conversation and enforcing protocols defined in the currently loaded and active conversation policy. It accepts text input from the multimodal processor 201, and validates it using text analyzer 205 to select the appropriate state transitions. The conversation support module 204 running on behalf of the system maintains the state of model creation. It accepts text messages from the user side conversation support module 203, and validates it with the text analyzer 206. The text input is converted to appropriate model artifacts and passed onto the model synthesizer 208.

The model synthesizer 208 holds in memory the instance of the model as it is being progressively created. Each instance will be based on a particular meta model 30. It will accept appropriate input from the conversation support module 204 to add or modify the in-memory model instance. In case of erroneous input, it will respond appropriately which then propagates back to the user. Given the current completion state of the model instance, it will solicit the next level of input from the user.

The conversation completes with a completed in-memory model instance 40. The model instance can then be exported to the file system in a suitable format, e.g., an XML file.

In the preferred embodiment of the invention, the browser implemented on the user computer interface 15 has a graphical representation of the model instance being created. The multimodal processor 201 is preferably implemented using IBM's Websphere Voice Server. The conversation support modules 203 and 204 are preferably implemented as conversation adapters employing IBM Alphaworks release—Conversation Support for Web Services. The preferred embodiment uses the Operation Model as the business proess meta model 30. An Operational Model Synthesizer 208 is created to corresponding to that and outputs the model instance 40 as an XML file.

As a specific example, the invention will be described in terms of a just-in-time (JIT) scheduling process. Suppose a valued customer informs the manufacturer that they wish to increase the quantity of a product that is on order and due to be shipped within the next three days. The order change request is received by the manufacturer's Fulfillment Department, which keeps a record of it and sends a “build schedule change request” to the Scheduling Department. The Scheduling Department is responsible for implementing the JIT Scheduling process.

The Scheduling department, upon receiving the build schedule change request, first uses a capacity scheduling application to determine whether the company has the capacity to produce the increased order quantity in the available time. If sufficient capacity is not available, then a negative response is returned to the Fulfillment Department. If, on the other hand, sufficient capacity is available, the next task is to check the supply plan to see if the planned inventories of all the raw materials needed for the increased order are expected to be in stock. If they are, then the build schedule change request is passed on to the “update build plan” task. Here the build plan is modified to reflect the increased production for the changed order, and a positive response is sent to the Fulfillment Department.

In the event that the supply plan indicates a shortage of one or more components needed to manufacture the product, in the check supply task a set of “part requests” is created, one for each component in short supply. Meanwhile, the build schedule change request is put into a “pending” state, which indicates that it cannot be further processed until processing of the part requests is completed. The part requests are processed individually by the “request supply” task, in which the company's procurement department consults a supplier profile database to look up the primary supplier(s) for that part. If the primary supplier is able to provide the increased quantity, then the pending request is updated with the required quantity of a part on the spot market. The results of this effort are used to update the pending request as well.

If any part cannot be acquired cannot be acquired in the required quantity, the pending request can be immediately processed by the “completion” task, and all remaining parts requests cancelled. The completion task returns a negative response to the Fulfillment Department. If and when all part requests are successfully returned, indicating that all parts could be procured, then the completion task can begin. In “completion”, the company considers the responses from the suppliers, including price, and decides whether to approve the build schedule change request. If the decision is negative, that message is returned to the Fulfillment Department. If the decision is positive, then the suppliers' pending orders are confirmed, the supply plan updated, and the acceptance of the build schedule change request is relayed back to the Fulfillment Department.

With this background example, a play-in scenario conversation for the JIT process will now be described as a dialog between the Analyst and the System. The bold-faced words are part of the play-in scenario vocabulary. During the conversation, the text analyzer extracts these keywords and passes them onto the conversation policies. These keywords are mapped to state transitions on the CPs and the output is either sent to the user as system response or to the model synthesizer as model input.
System: How may I help you?
Analyst: I would like to create a new process model.
System: How many Business Artifacts do you have in this model?
Analyst: Don't know. What is a Business Artifact?
System gives a description to the Analyst.
System: Could you tell me one Business Artifact you have in this process?
Analyst: Base Request (BR) seems to be one.
System: What is it made of or what is the least information that must be present to recognize it as a Base Request?
Analyst: Order ID of the order to be changed and the Changed Quantity.
System: What are the Business Tasks that works on the artifact?
Analyst: Don't know. What is a Business Task?
System gives a description to the Analyst.
System: Could you tell me the first task that acts on the Base Request?
Analyst: Check Capacity seems to be one.
System: Does the Check Capacity task use any other artifact?
Analyst: Yes, the Build Plan artifact.
System: Does the Check Capacity task change any artifact?
Analyst: Yes, record whether capacity is available to satisfy the request or not on the Base Request.
Record all changes made to each artifact.
System: Are any new artifacts produced?
Analyst: No (if Yes, the new artifact is added to a list of artifacts).
System: What is the next Task?
Etc. (The above is repeated for each artifact in the artifact list.)

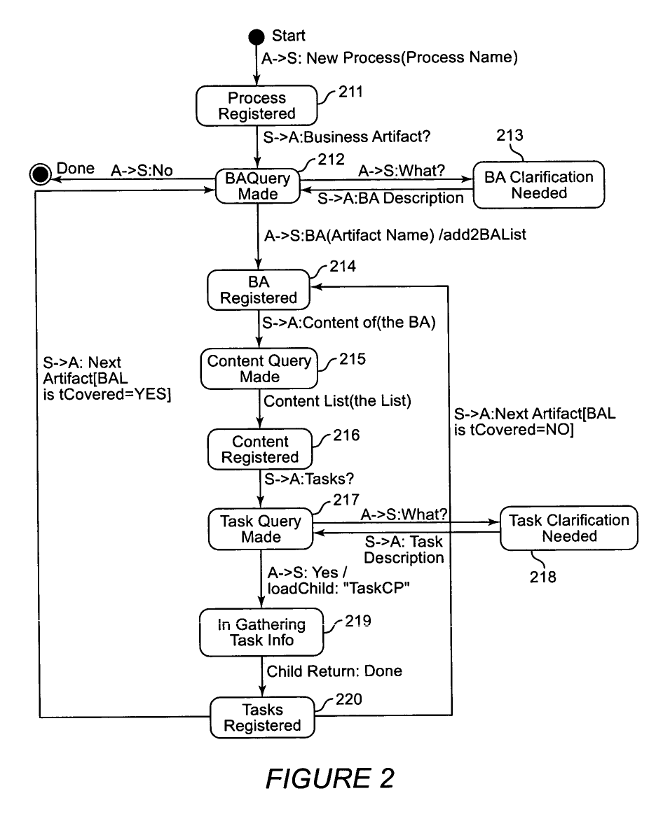

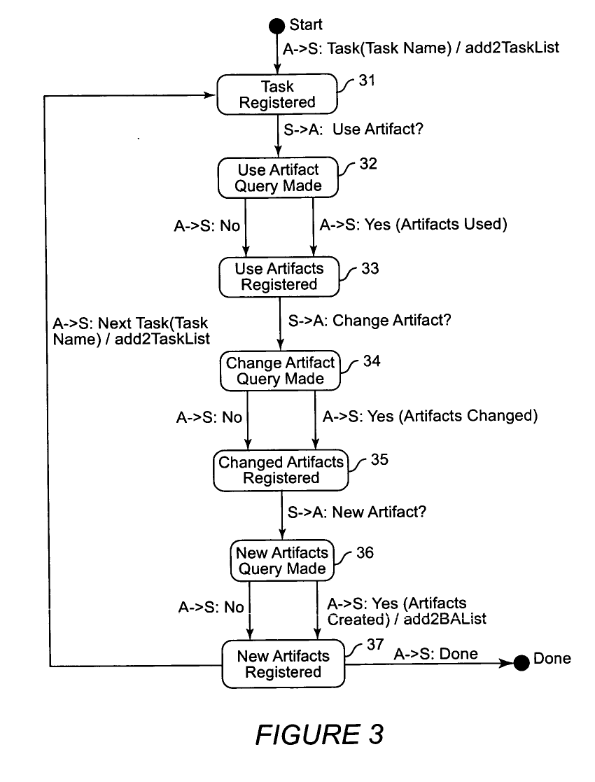

The process is illustrated in the state chart diagram of FIG. 2. At the start, the Analyst tells the System the new process (i.e., the process name). In function block 211, the System registers the process. The System then asks the Analyst whether there are any Business Artifacts. In our dialog example above, the Analyst asks the System what a Business Artifact (BA) is. The query is detected in decision block 212 and an explanation is provided by the System to the Analyst in function block 213. Once the query has been answered, or if no query is made, the Analyst provides the System with a Business Artifact name, which name is added to the Artifact List and registered by the System in function block 214. The System then asks the Analyst for the content of the Business Artifact. In our dialog example above, the Analyst asks the System what Content is. The query is detected in decision block 215 and an explanation is provided by the System to the Analyst. Once the query has been answered, or if no query is made, the Analyst provides the System with a Content list, and the System registers the Content List in function block 216. The System then asks the Analyst for Tasks. Again, in our dialog example above, the Analyst asks the System what a Task is. The query is detected in decision block 217 and an explanation is provided by the System to the Analyst in function block 218. Once the query has been answered, or if no query is made, the Task CP is loaded as a child and details about the tasks that affect the current artifact is gathered using the Task CP in the state chart shown in FIG. 3. While the task information is being obtained the parent Artifact CP processing is halted in block 219. The termination of the task CP restarts the Artifact CP, and the System registers the Tasks in function block 220. A determination is made as to whether all Business Artifacts have been covered for the new process, and if not, a return is made to function block 214 to register the next Business Artifact. If all Business Artifacts have been registered, then a return is made to decision block 212, and the process completes.

The process of the Task play-in scenario conversation policy (CP) is shown in the flow diagram of FIG. 3. At the start, the Analyst tells the System the Task Name, and the System registers the Task Name in function block 301. The System then asks the Analyst whether the Business Artifact is to be used in function block 302, and the System detects whether the Analyst answers with a Yes or a No. In function block 303 the registered Artifact are used. Then, the System asks the Analyst whether an artifact is to be changed in function block 304, and the System detects whether the Analyst answers with a Yes or a No. In function block 305, changed Artifacts are registered. A new Artifacts query is made by the System in function block 306, and the System detects whether the Analyst answers with a Yes or No. New Artifacts are registered in function block 307. A determination is made as to whether all Tasks have been covered, and if not, a return is made to function block 301 to register the new task; otherwise, the process ends.

The information gathered for the JIT process in this example is summarized below:
Business Process

Fulfillment
Artifacts

Base Request
Contains: order ID, changed quantity

Parts Request
Contains: part ID, quantity required
Supporting Artifacts

Build Plan

Supply Plan

Vendor Profile
Tasks

Check Capacity
Uses: Base Request, Build Plan
Modifies: Base Request

Check Supply
Uses: Base Request, Supply Plan
Modifies: Base Request, Supply Plan
Produces: Parts Request

Update Schedule
Uses: Base Request
Modifies: Build Plan, Base Request

Source Parts
Uses: Parts Request, Base Request
Modifies: Parts Request, Base Request

Spot Purchase
Uses: Parts Request, Base Request
Modifies: Parts Request, Base Request

The synthesized JIT Process Model for the example given is shown in the block diagram of FIG. 5. This is the model produced as the output 40 and displayed on the user computer interface 15 in FIG. 1. The customer 401 makes a request to the Fulfillment Department 402 for an increase in the product order. The Fulfillment Department 402 sends the Base Request to the Scheduler 403 to check capacity in block 404. If there is no capacity, a negative answer is returned to the Fulfillment Department 402. If, on the other hand, there is sufficient capacity, the Base Request is forwarded to the check supply block 405. A Parts Request is forwarded to the Procurement Department 406, and parts are requested at block 407, and at the same time the Base Request is forwarded to block 408. The Parts Request is forwarded to the source parts block 409 which contacts the primary supplier and possibly secondary suppliers (e.g., the spot market) 410. Parts are procured from either or both the primary supplier or secondary suppliers (spot purchase block 411), and committed parts are registered in block 412. The Parts Request from block 412 and the Base Request from block 408 are sent to block 413 to update the supply plan. If it is determined that the request cannot be fulfilled, a negative response is returned to the Fulfillment Department 402; otherwise, the supply plans 414 forwarded from check supply block 405 are updated, and the Base Request is sent to the update schedule block 415. A new build plan is generated in block 416 which is forwarded to the check capacity block 404, and the Base Request is returned to the Fulfillment Department 402.

While the invention has been described in terms of a single preferred embodiment, those skilled in the art will recognize that the invention can be practiced with modification within the spirit and scope of the appended claims.

1. A system that enables people to create business process models by multimodal conversations comprising:
a multimodal processor for receiving input from a user and providing output to the user, the multimodal processor converting user input to text and converting text responses to the user to output to the user;
a user conversation support module receiving text from the multimodal processor and accessing a text analyzer to extract keywords based on a conversation vocabulary, and use the keywords to, enforce protocols defined in currently loaded, and select appropriate state transitions;
a system conversation support module which maintains a state of model creation by accepting text messages from the user conversation support module and converting the text messages to appropriate model artifacts; and
a model synthesizer receiving the model artifacts from the system conversation support module and holding in memory an instance of a model as it is being progressively created, each instance being based on a particular meta model, the model synthesizer accepting appropriate input from the system conversation support module to add or modify the in-memory model instance, and when the conversation completes, the model synthesizer outputting a completed in-memory model instance.

2. The system recited in claim 1, wherein when an erroneous input is detected by the model synthesizer, the model synthesizer responds appropriately which then propagates back to the user.

3. The system recited in claim 1, wherein the model output from the model synthesizer is a file.

4. The system recited in claim 1, wherein the model output from the model synthesizer is displayed to the user as the model is being synthesized.

5. The system recited in claim 1, wherein the multimodal processor integrates functions of voice recognition and speech synthesis and accepts spoken input from the user and generates audible speech output to the user.

6. The system recited in claim 5, wherein the multimodal processor further integrates functions of keystroke and pointing device capture and accepts user input from a keyboard and pointing device.

7. The system recited in claim 5, further comprising a video capture device for capturing images of the user and wherein the multimodal process further integrates the function of detecting and recognizing gestures made by the user.

8. A computer implemented method that enables people to create business process models by multimodal conversations comprising the steps of:
receiving input from a user and providing output to the user;
converting user input to text and converting text responses to the user to output to the user;
receiving converted text from the user and accessing a text analyzer to maintain a state of conversation, enforce protocols defined in currently loaded, and select appropriate state transitions;
maintaining a state of model creation by accepting converted text messages from the user and converting the text messages to appropriate model artifacts;
receiving the model artifacts and holding in memory an instance of a model as it is being progressively created, each instance being based on a particular meta model;
accepting appropriate input to add or modify the in-memory model instance, and when the conversation completes, outputting a completed in-memory model instance.

9. The computer implemented method recited in claim 8, further comprising the steps of:
detecting an erroneous input; and
responding appropriately to the user.

10. The computer implemented method recited in claim 8, wherein the model output is a file.

11. The computer implemented method recited in claim 8, wherein the model output is displayed to the user as the model is being synthesized.
